(19) United States
(12) Patent Application Publication
(10) Pub. No.: US 2012/0044624 A1
(43) Pub. Date: Feb. 23, 2012

(54) HANDLE ASSEMBLY FOR A PORTABLE ELECTRONIC DEVICE

(76) Inventors: Dustin L. Hoffman, Cypress, TX (US); Memphis-Zhihong Yin, Tomball, TX (US); Eric Chen, Houston, TX (US)

(21) Appl. No.: 12/861,050

(22) Filed: Aug. 23, 2010

(51) Int. Cl. G06F 1/16

(52) U.S. Cl. 361/679.21; 361/679.59

(57) ABSTRACT

Embodiments of the present invention disclose a hermetic seal apparatus for a portable electronic device. According to one embodiment, the portable electronic device includes a housing for enclosing processing components. In addition, the portable electronic device includes a handle assembly affixed to the housing and having at least one integrated I/O port electrically coupled to the processing component.

### BACKGROUND

The emergence and popularity of mobile computing has made portable electronic devices, due to their compact design and light weight, a staple in today's marketplace. Most portable electronic devices include an input/output port for providing additional functionality to the portable electronic device. For example, a universal serial port (USB) may be included with the portable electronic device for connecting to peripheral devices such as a printer or external mouse for example, and/or an Ethernet port may be included with the portable electronic device for connecting to a local area network. However, some portable electronic devices, particularly small notebook computers, are limited by their size as to the number of port solutions they can provide in addition to their means of transport.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIG. 1 is a three-dimensional perspective view of a portable electronic device according to an embodiment of the present invention.

FIG. 2A is a three-dimensional perspective view of the handle assembly in a closed non-carrying position according to an embodiment of the present invention.

FIG. 2B is a three-dimensional perspective view of the handle assembly in an opened carrying position according to an embodiment of the present invention.

FIG. 3 is a simplified cross-sectional view of the handle assembly according to an embodiment of the present invention.

FIGS. 4A and 4B are views illustrating general operating environments of the handle assembly and portable electronic device according to an embodiment of the present invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” and “e.g.” are used in an open-ended fashion, and thus should be interpreted to mean “including, but not limited to . . . ”. The term “couple” or “couples” is intended to mean either an indirect or direct connection. Thus, if a first component couples to a second component, that connection may be through a direct electrical connection, or through an indirect electrical connection via other components and connections, such as an optical electrical connection or wireless electrical connection. Furthermore, the term “system” refers to a collection of two or more hardware and/or software components, and may be used to refer to an electronic device or devices, or a sub-system thereof.

### DETAILED DESCRIPTION OF THE INVENTION

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Prior solutions include port replicators in which a notebook computer is placed on top of a base station for extending the number of available ports. However, these port replicators are similar in size to the notebook computer to which it is connected and therefore inconvenient for transport. Furthermore, transporting a notebook computer can be tricky, especially in a school environment. For example, transporting a notebook computer in a backpack often takes up space for other items, such as schoolbooks. Accordingly, there is a need in the art for a more efficient and intuitive solution for transporting and extending the connective abilities of a portable electronic device such as a notebook computer.

Embodiments of the present invention provide a handle assembly for a portable electronic device. According to one embodiment, the handle assembly attaches to the chassis of a portable electronic device via brackets positioned on the bottom surface of the portable electronic device. The handle assembly includes an elongated gripping portion and arm portions configured to connect to the brackets. Furthermore, the handle assembly includes a plurality of ports horizontally-arranged along the gripping portion. Accordingly, embodiments of the present invention help to supplement the number of available input/output ports of the portable electronic device while also providing a mechanism for easily transporting the portable electronic device.

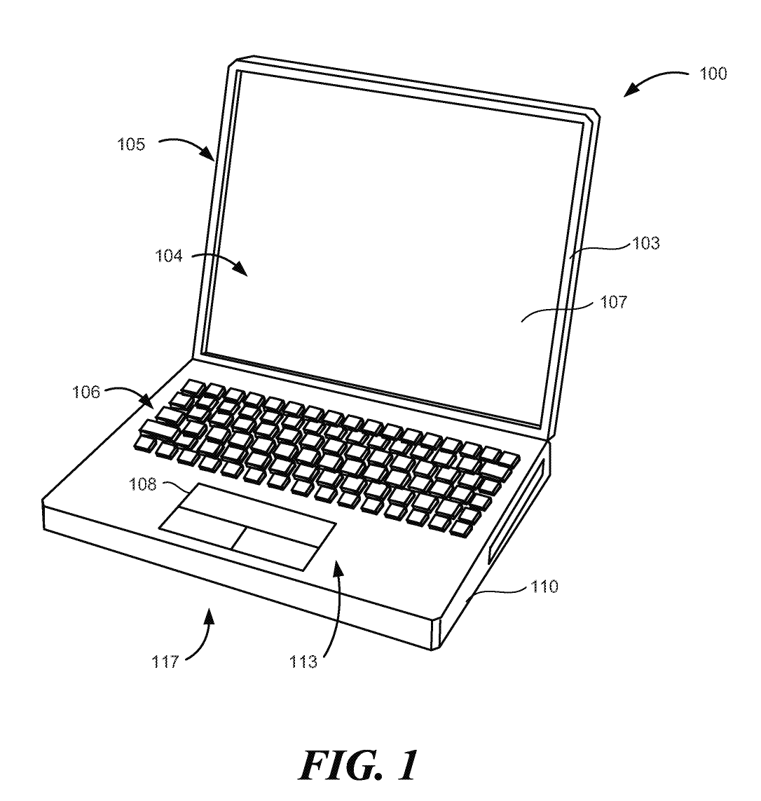

Referring now in more detail to the drawings in which like numerals identify corresponding parts throughout the views, FIG. 1 is a three-dimensional perspective view of a portable electronic device according to an embodiment of the present invention. Portable computer 100 represents the portable electronic device having a chassis that includes an upper housing 105 and a base housing 110. The upper housing, or display panel housing 105, includes a display device 107 having electrical wiring adapted to provide graphical display to a user on its front surface side 104. As further shown in FIG. 1, the base housing 110 includes a top surface 113 and bottom surface 117 that is opposite the top surface 113. According to one embodiment, the top surface 113 of the base housing 110 may include an input means for operation by user such as a keyboard 106 and touch pad 108.

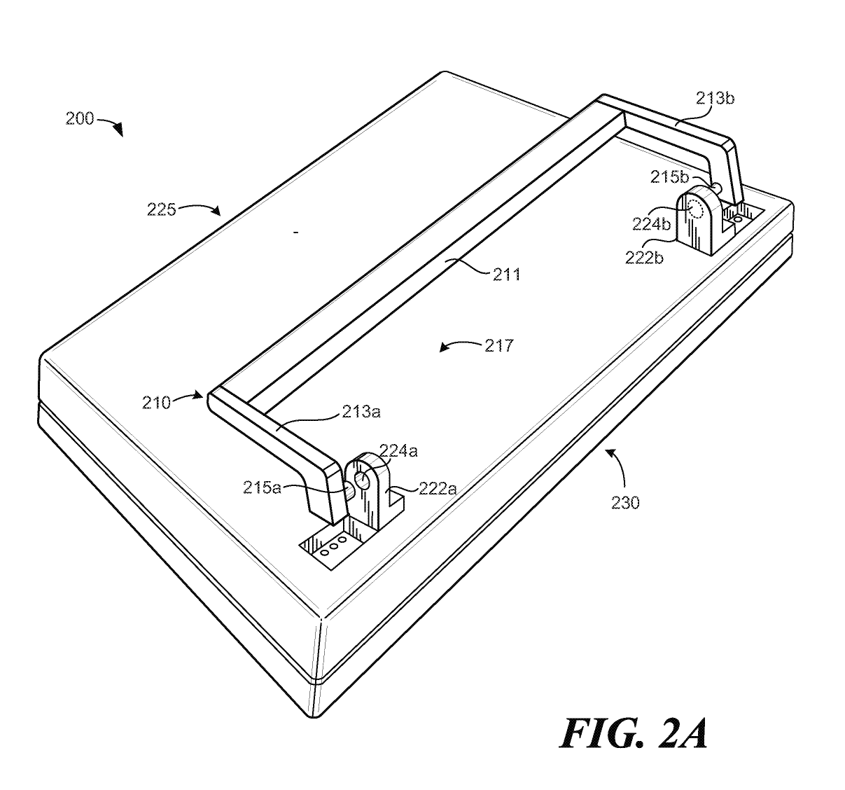

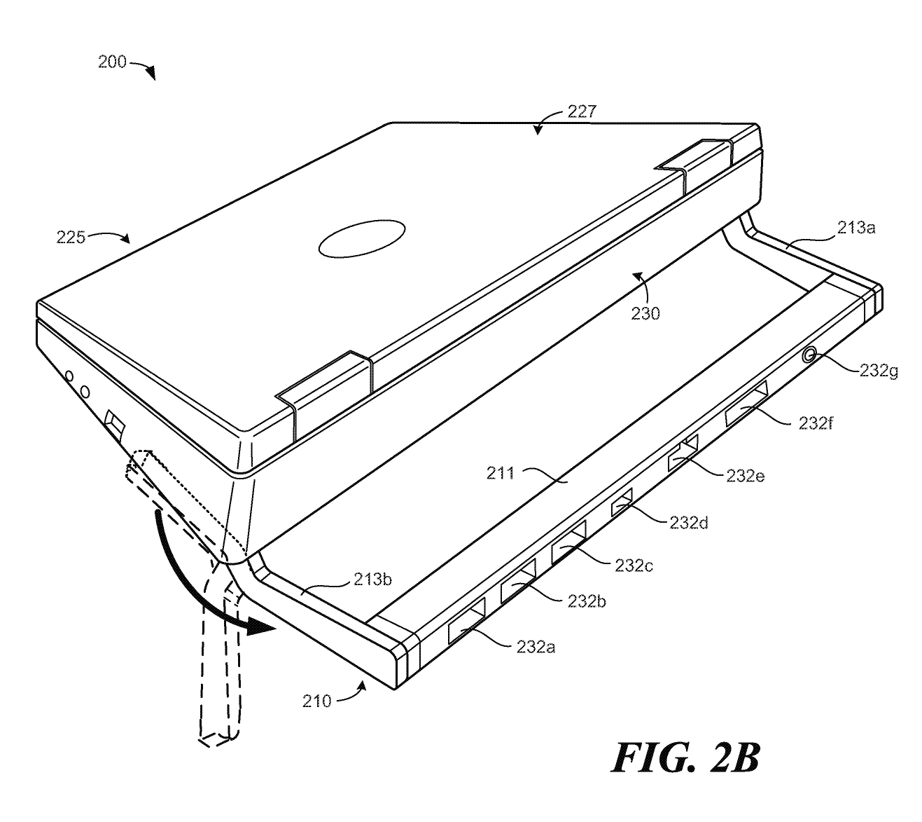

FIG. 2A is a three-dimensional perspective view of the handle assembly in a closed non-carrying position according to an embodiment of the present invention. As shown here, the portable electronic device includes a bottom surface side 217 and a front end side 225 opposite a back end side 230. Furthermore, a pair of bracket members 222a and 222b are positioned on the bottom surface side 217 near the back end side 230 of the portable electronic device 200. In addition, each bracket member 222a and 222b includes an aperture 224a and 224b respectively for receiving the handle assembly 210. Still further, a pair of docking connectors 226a and 226b are positioned adjacent to the bracket members 222a and 222b. The handle assembly 210 includes an elongated gripping portion 211 and a pair of arm portions 213a and 213b formed at opposite ends of the gripping portion 211. In the closed non-carrying position, the elongated gripping portion 211 of the handle assembly 210 is positioned in close proximity to the bottom surface side 217 of the portable electronic device 200, while the arm portions 213a and 213b extend from the bracket members 222a and 222b towards the front end side 225 of the portable electronic device. Additionally, each arm portion 213a and 213b includes a protruding shaft portion 215a and 215b respectively for insertion into the aperture 224a and 224b of the bracket members 222a and 222b. According to one example, placement of the protruding shaft portions 215a and 215b within the apertures 224a and 224b of the bracket members 222a and 222b forms a flexible ratcheting mechanism so as to allow the handle assembly to be rotated and fixed to a usable position. As such, the handle assembly 210 is firmly affixed to the base housing via the bracket members and arm portions. Although the handle assembly is described as being separate from the bracket members 222a and 222b, the handle assembly 210 may also include bracket members 222a and 222b and/or docking connectors 226a and 226b.

FIG. 2B is a three-dimensional perspective view of the handle assembly in an open carrying position according to an embodiment of the present invention. In the present example, the portable electronic device 200 is rotated 180° with respect to the example shown in FIG. 2A such that the upper surface side 227 of the portable electronic device 200 is visible. Furthermore, the handle assembly 210 is rotated approximately 90° from a non-carrying position (FIG. 2A) to an opened carrying position in which the arm portions 213a and 213b extend from the bracket members towards the back end side 230 of the portable electronic device, and the gripping portion 211 is positioned away from bottom surface side 217 (shown in FIG. 2A) of the portable electronic device 200. As shown here, the elongated gripping portion 211 includes a plurality of integrated input/output (I/O) ports 232a-232g formed horizontally-adjacent to one another. In the present example, ports 232a-232g represents a specialized outlet for interfacing a computer or peripheral device via a plug or cable. In the present example, ports 232a-232c may represent a universal serial bus (USB) port for receiving a USB cable, port 232d represents a IEEE 1398 interface port (e.g. “FireWire”) for receiving a compatible cable, port 232e represents an Ethernet port for receiving an Ethernet cable, port 232f represents a high-definition multimedia interface (HDMI) port for receiving an HDMI cable, and port 232g represents a female headphone socket for receiving a jack plug associated with a pair of headphones. However, the I/O ports of the present embodiments are not limited therein and may include a serial port, parallel port, PS/2 port, or any other similar specialized female electrical contact or socket configured to communicate data between devices.

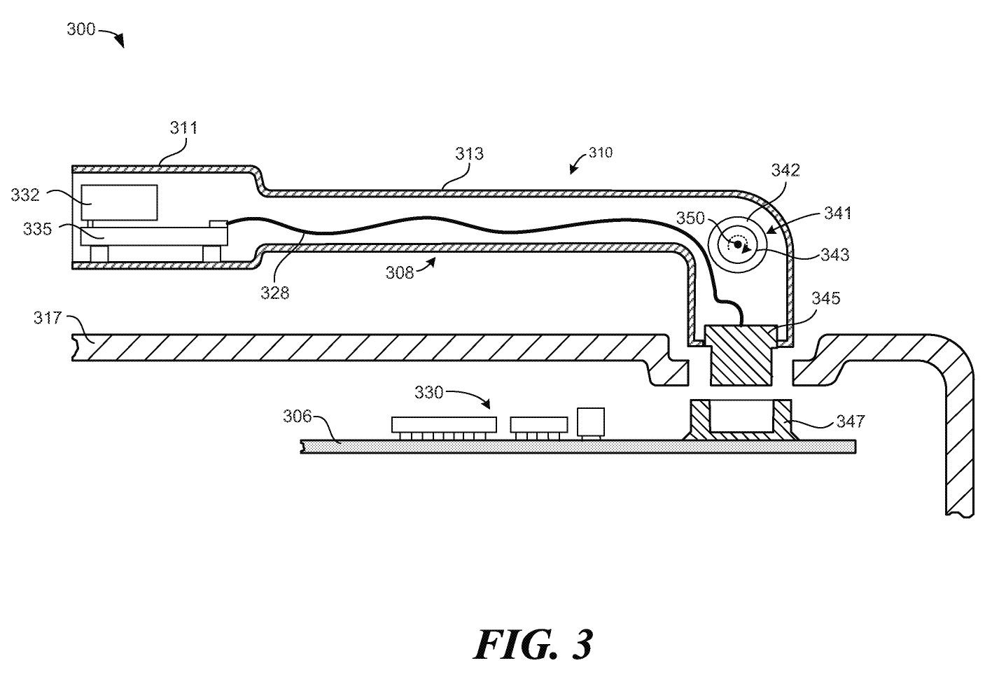

FIG. 3 is a simplified cross-sectional view of the handle assembly according to an embodiment of the present invention. In the following example, the portable electronic device is in a closed non-carrying position in which an under area 308 of the handle assembly faces the bottom surface 317 of the portable electronic device. As in the previous example, the handle assembly 310 includes a gripping portion 311, an arm portion 313, and at least one electrical I/O port 332. The port 332 is coupled to an electrical contact 335 configured to transmit and receive data to/from the portable electronic device via electrical wiring 328. More particularly, electrical wiring 328 runs through the entire handle assembly, thereby allowing the handle assembly 310 to be populated with multiple ports and connectors. Furthermore, the cable is coupled to a male docking connector 345, which is configured to seat into the female docking connector 347. Moreover, and as shown in the present example, the female docking connector 347 is coupled to the printed circuit board 306 and integrated circuits 330 of the portable electronic device. The protruding shaft 343 of the arm potion 313 is configured to fit within the aperture 342 of the bracket member so as to form a rotatable hinge 341 for the handle assembly 310. In particular, the handle assembly rotates about an axis of rotation 350 (indicated by dotted curved arrow) associated with hinge 341.

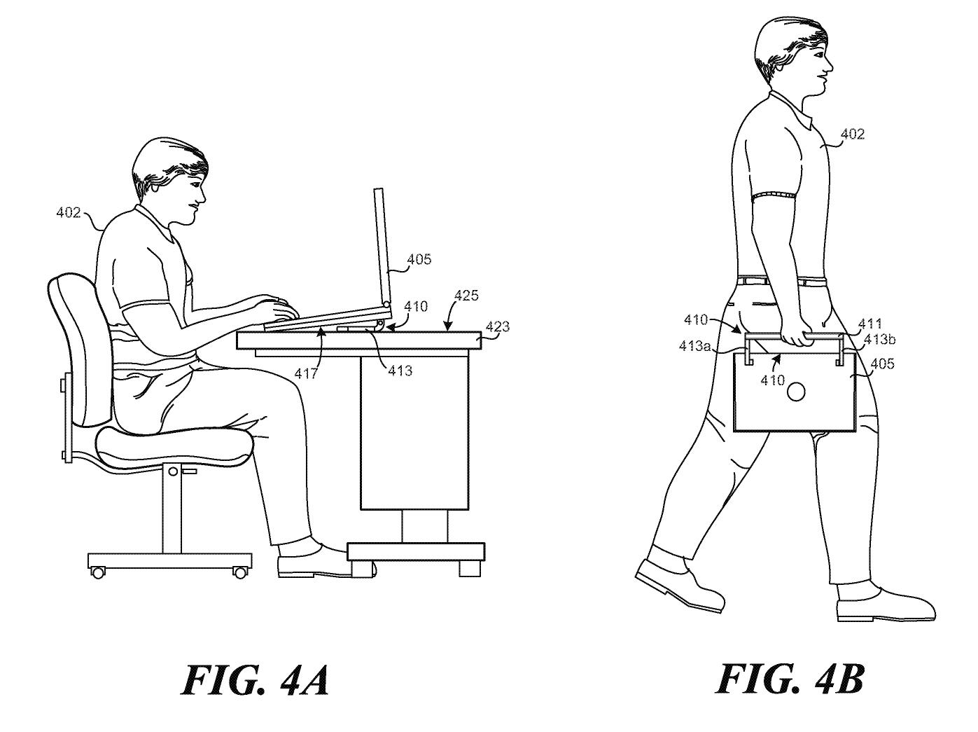

FIGS. 4A and 4B are views illustrating general operating environments of the handle assembly and portable electronic device according to an embodiment of the present invention. As shown in FIG. 4A, the mounting bracket and arm portions 413 of the handle assembly 410 may serve as a foot rest for the portable electronic device when the gripping portion of the handle assembly is not in use (i.e. non-carrying position). That is, when the portable electronic device is in a normal operating position, the arm portion 413 of the handle assembly 410 abuts the operating surface 425 (associated with desk 423) so as to lift the back end side of the bottom surface 417 of the portable electronic device 405 from the operating surface 425. For example, the keyboard of a notebook computer may be inclined in order to provide the operating user 402 with a more natural and convenient typing and viewing position. Alternatively, and as shown in the example of FIG. 4B, the handle assembly 410 of the portable electronic device 405 may also be placed in an opened carrying position. That is, the gripping portion 411 of the handle assembly 410 may be rotated 90° about the hinge's axis of rotation such that the arm portions 413a and 413b of the handle assembly 410 extend away from the bracket members towards the back end side 410 of the portable electronic device 405. As such, a user 402 may hold the handle assembly via the exposed gripping portion 411 in order to easily transport the portable electronic device 405.

Embodiments of the present invention provide a handle assembly for a portable electronic device. In particular, a handle assembly includes at least one I/O port for interfacing the portable electronic device with other devices while also functioning as a foot rest for the portable electronic device. Accordingly, many advantages are afforded by the handle assembly of embodiments of the present invention. For example, such a configuration provides additional functionality for the portable electronic device via the increased number of connectivity options and input/output ports, while also providing the user with an effective and convenient option for carrying the portable electronic device.

Furthermore, while the invention has been described with respect to exemplary embodiments, one skilled in the art will recognize that numerous modifications are possible. For example, although exemplary embodiments depict a notebook computer as the portable electronic device, the invention is not limited thereto. For example, the portable electronic device may be a netbook, a tablet personal computer, a smartphone, or any similar electronic computing device having a chassis that houses processing components and is convenient in size for transport.

Furthermore, the handle assembly may be formed at any position on the portable electronic device. For example, the handle assembly may be positioned on the back end side or the upper surface side of the portable electronic device, rather than the bottom surface side as described and depicted in the present examples. Thus, although the invention has been described with respect to exemplary embodiments, it will be appreciated that the invention is intended to cover all modifications and equivalents within the scope of the following claims.

What is claimed is:

1. A portable electronic device system comprising:
a housing for enclosing processing components; and
a handle assembly affixed to the housing, wherein the handle assembly includes at least one integrated I/O port electrically coupled to the processing components.

2. The portable electronic device of claim 1, wherein the handle assembly includes a pair of arm portions coupled to an elongated gripping portion at opposite ends thereof.

3. The portable electronic device of claim 1, further comprising:
a pair of bracket members affixed to a bottom surface side of the housing, wherein the pair of arm portions of the handle assembly are connected to the pair of bracket members at the bottom surface side of the housing.

4. The portable electronic device of claim 3, wherein the handle assembly is configured to pivotally rotate from a first position to a second position about a hinge associated with the pair of bracket members.

5. The portable electronic device of claim 4, wherein when in a first position, the gripping member of the handle assembly is positioned in close proximity to the bottom surface side of the housing and the arm portions of the handle assembly extend from the bracket members towards a front end side of the portable electronic device.

6. The portable electronic device of claim 5, wherein when in a second position, the gripping member of the handle assembly is positioned further away from the bottom surface side of the housing than in the first position, and the arm portions of the handle assembly extend from the bracket members towards a back end side of the portable electronic device.

7. The portable electronic device of claim 2, wherein the handle assembly includes a plurality of I/O ports horizontally-arranged along the gripping portion of the handle assembly.

8. A computing system comprising:
a first housing including electrical components for providing display to a user;
a second housing pivotably connected to the first housing, wherein the second housing includes processing components housed therein; and
a handle assembly affixed to a bottom area of the second housing, wherein the handle assembly includes at least one integrated I/O port electrically coupled to the processing components.

9. The computing system of claim 8, wherein the handle assembly includes a pair of arm portions coupled to an elongated gripping portion at opposite ends thereof.

10. The computing system of claim 8, further comprising:
a pair of bracket members affixed to the bottom area of the second housing, wherein the pair of arm portions of the handle assembly are connected to the pair of bracket members at the bottom area of the second housing.

11. The computing system of claim 10, wherein the handle assembly is configured to pivotally rotate from a first position to a second position about a hinge associated with the pair of bracket members.

12. The computing system of claim 11, wherein when in a first position, the gripping member of the handle assembly is positioned in close proximity to the bottom area of the second housing and the arm portions of the handle assembly are extended towards a front end side of the computing system.

13. The computing system of claim 12, wherein when in a second position, the gripping member of the handle assembly is positioned further away from the bottom area of the base housing than in the first position, and the arm portions of the handle assembly are extended from the bracket members towards the back end side of the computing system.

14. The computing system of claim 9, wherein the handle assembly includes a plurality of I/O ports horizontally-arranged along the gripping portion of the handle.

15. A portable electronic device comprising:
a display housing;
a base housing pivotably connected to the display housing and having processing components stored therein;
a pair of bracket members affixed to the bottom area of the base housing; and
a handle assembly including a pair of arm portions coupled to an elongated gripping portion at opposite ends thereof and affixed to the pair of bracket members;
wherein the handle assembly includes at least one integrated I/O port electrically coupled to the processing components housed within the base housing.

16. The portable electronic device of claim 15, wherein the handle assembly is configured to pivotally rotate from a first position to a second position about a hinge associated with the pair of bracket members.

17. The portable electronic device of claim 16, wherein when in a first position, the gripping member of the handle is positioned in close proximity to the bottom area of the base housing and the arm portions of the handle are extended from the bracket members towards a front side end of the portable electronic device.

18. The portable electronic device of claim 16, wherein when in a second position, the gripping member of the handle assembly is positioned further away from the bottom area of the base housing than in the first position, and the arm portions of the handle assembly are extended from the bracket members away from the back side of the portable electronic device.

19. The portable electronic device of claim 15, wherein the handle assembly includes a plurality of I/O ports horizontally-arranged along the gripping portion of the handle.
